(19) United States
(12) Patent Application Publication
(10) Pub. No.: US 2005/0257199 A1
(43) Pub. Date: Nov. 17, 2005

(54) Method of and system for performance analysis and software component installation

(76) Inventors: Enrico Johansson, Malmo (SE); Johan Eker, Lund (SE); Fredrik Wartenberg, Hjarup (SE)

Correspondence Address: ERICSSON INC., 6300 LEGACY DRIVE, M/S EVR C11, PLANO, TX, 75024, US

(21) Appl. No.: 10/844,833

(22) Filed: May 13, 2004

(51) Int. Cl. G06F 9/44

(52) U.S. Cl. 717/126

(57) ABSTRACT

A software performance-analysis and installation method includes estimating performance of a system including a software component to be installed on the system and determining, based on the estimated performance, whether to install the software component in a current configuration. The software component is installed in the current configuration responsive to a determination to install the software component in the current configuration. At least one of the following four steps is performed responsive to a determination not to install the software components to be installed in the current configuration: (1) deleting at least one software component of the system; (2) determining a new usage profile; (3) aborting installation of the software component to be installed; and (4) selecting an alternative component to be installed. This Abstract is provided to comply with rules requiring an Abstract that allows a searcher or other reader to quickly ascertain subject matter of the technical disclosure. This Abstract is submitted with the understanding that it will not be used to interpret or limit the scope or meaning of the claims. 37 CFR 1.72(b).

### BACKGROUND OF THE INVENTION

1. Technical Field

The present invention relates generally to installation of software components and, more particularly, but not by way of limitation, to performing analyses of system performance relative to software components to be installed on the system.

2. History of Related Art

Many existing systems containing software can install and execute new software components, which can be any software from a full-fledged application to a small utility function or device driver. A vast variety of downloadable software applications are available, particularly for devices built upon published application programming interfaces (APIs). The ability of the systems to install and execute the software components, together with the large number of available software applications, may present challenges.

It has to date been very difficult, if not impossible, to determine all possible configurations of software applications that can be installed and executed in a given system. When a software configuration of the system is altered, there is a risk of adversely affecting system performance. If, however, the system performance including newly-added software applications could be predicted, installation guidelines and load balancing could possibly be used to improve the system's performance.

Software updates are often performed using a file containing the software update and an installer program that applies the software update. To overcome possible complications that may arise during a software update, installer programs may perform a wide range of checks and controls before effectuating the software update. It is common to check whether or not the system to be updated fulfils various prerequisites in terms of already-installed software and available memory.

### SUMMARY OF THE INVENTION

A software performance-analysis and installation method includes estimating performance of a system including a software component to be installed on the system and determining, based on the estimated performance, whether to install the software component in a current configuration. The software component is installed in the current configuration responsive to a determination to install the software component in the current configuration. At least one of the following four steps is performed responsive to a determination not to install the software components to be installed in the current configuration: (1) deleting at least one software component of the system; (2) determining a new usage profile; (3) aborting installation of the software component to be installed; and (4) selecting an alternative component to be installed.

An article of manufacture for software performance-analysis and installation includes at least one computer readable medium and processor instructions contained on the at least one computer readable medium. The processor instructions are configured to be readable from the at least one computer readable medium by at least one processor. The processor instructions cause the at least one processor to operate as to estimate performance of a system including a software component to be installed on the system and determine, based on the estimated performance, whether to install the software component in a current configuration. The processor instructions also cause the at least one processor to operate at to install the software in the current configuration responsive to a determination to install the software component in the current configuration. The processor instructions also cause the at least one processor to operate as to perform at least one of the following four operations responsive to a determination not to install the software component to be installed in the current configuration: (1) delete at least one software component of the system; (2) abort installation of the software component to be installed; (3) determine a new usage profile; and (4) select an alternative software component to be installed.

### BRIEF DESCRIPTION OF THE DRAWINGS

A more complete understanding of the present invention may be obtained by reference to the following Detailed Description of Exemplary Embodiments of the Invention, when taken in conjunction with the accompanying Drawings, wherein:

FIG. 1 is a flow chart illustrating performance analysis and software-component installation in accordance with principles of the invention; and

FIG. 2 is a hardware accelerator in accordance with principles of the invention.

### DETAILED DESCRIPTION OF EXEMPLARY EMBODIMENTS OF THE INVENTION

Embodiment(s) of the invention will now be described more fully with reference to the accompanying Drawings. The invention may, however, be embodied in many different forms and should not be construed as limited to the embodiment(s) set forth herein. The invention should only be considered limited by the claims as they now exist and the equivalents thereof.

Selection of different downloadable software applications for handheld devices is growing rapidly. A wide variety of software applications are available that can be built using a number of software techniques such as, for example, .net, Java, and native programming languages. The downloadable software applications may be subject to real-time requirements, such as those imposed by, for example, communication protocols. Regardless of which software technique is used or any real-time requirements, there is a risk that the system performance will be degraded once the newly-added software applications are executed along with other software in the system.

To avoid unwanted effects due to software component installation, the system may allow the user, prior to downloading a software component, to decide whether or not a likely system-performance degradation is acceptable. In another scenario, downloading and installation of the software component is managed so that any system-performance degradation is minimized. The system-performance degradation can, in some circumstances, result in a workload that exceeds the processing power of available hardware. The system-performance degradation may also result in unacceptably-long response times. Taken to extremes, the system-performance degradation can result in the system becoming completely unusable.

The system-performance degradation may be due not only to a software malfunction, but may even be caused by the newly-added software component not being optimally configured or requiring too much processing power. There is also a risk that the system impact will cause the newly-added software component to not achieve required real-time characteristics, which is very undesirable, as the newly-added software component thereby becomes useless.

Handheld devices are typical systems into which a user may install downloadable software components and in which hardware processing power is a critical resource. Some handheld devices can be viewed as embedded systems with distributed processing capability, where processing may be distributed between, for example, a communication central processing unit (CPU), an application CPU, and various hardware accelerators. It is very difficult, if not impossible, for a user to be certain that the installation of a given software component will not render the handheld device useless, unless there is support in estimating the impact of anticipated software-component installations. When a performance-impact estimation is accomplished on the handheld device, rather than in advance, the potentially-large number of relevant system configurations may be better taken into account.

A component installer takes into consideration the system performance prior to a run-time installation of the software component. The component installer may, prior to download, send system performance estimates to a user via an appropriate interface. The performance estimates take into consideration effects that the new software component to be installed will likely have on the system. Based on the estimated system performance, the user can make appropriate choices whether or not to download and install the software component.

In another option, the component installer works in the background without presenting estimates to the user; thus, the user is not expected to make an explicit choice, but rather relies on mechanisms, which may be internal to the system, to make the necessary decision(s). A system configuration that is optimal with respect to some predefined criteria or criterion is chosen. Such criterion or criteria can be, for example, system workload, response time for a specific use case or single applications, or a combination thereof.

In a multi-processor system, configuration choices can be, for example, which CPU the software component should be executed on. In a layered architecture, the configuration choices could include, for example, on which level the software component should be placed. Other configuration choices may include, for example, choice of priority or CPU bandwidth on and communication bandwidth for concurrent activities encapsulated in the software component that can be tuned by the component installer, based on the system-performance estimation.

Apart from obvious end-user benefits, such as, for example, a well-configured system, the component installer can be adapted to protect the performance of critical functionality already installed in the system. The critical functionality may be, for example, functionality available on delivery from a system manufacturer.

The component installer estimates the system's performance with the new component included in the system by performing various calculations. Inputs used in the calculations may include configuration descriptions of the system as currently configured and configuration descriptions for the software component to be installed. The configuration descriptions for the system typically include a description of the structure of the software currently on the system, including a number of software components and their interrelationship in terms of dynamic and static call dependencies. A static dependency can, for example, be described by what APIs are exported to the system by each of the software components and required by the software components from the system. The configuration descriptions for the system also typically include an average number of calls for each of the dependencies, such as, for example, how many times, on average, a given software component calls another software component via an API. The configuration descriptions also typically include average service requirements of each software component in terms of hardware-processing demand.

The configuration descriptions for the system also typically include usage profiles describing the probability rate at which specific software components are executed by the user. The usage profiles can, for example, be built by static analysis or by dynamically monitoring and storing the number of calls to specific APIs or processes during a certain time period. If dynamic usage profiles are used, the probabilities may be recalculated at specific time intervals or triggered by specific events. In the case of static profiles, there can be a number of different choices stored in the system. The most appropriate choice may be selected by the system itself according to some given criterion or criteria or selected manually by the user.

A database may be used to store relevant data pertaining to the current performance characteristics of the system. The database may be updated during run-time execution of the system and may be implemented as an internal database in the system (e.g., handheld device) or in an external database.

In addition to the configuration descriptions for the system, configuration descriptions of the software component to be installed are used. The configuration descriptions of the software component to be installed typically include component requirements in terms of hardware and software system resources. The hardware and software component requirements typically include hardware requirements in terms of processor, memory, and hardware accelerator usage, software requirements in terms of required services from other software, which may be described in terms of needed APIs from other software components, and acceptable response times from the system in order to deliver functionality of the software component to be installed to the user. The configuration descriptions for the software component to be installed also typically include necessary processing speeds (e.g., required frame rates for video decoding).

The configuration descriptions for the software component to be installed may be packed together with a software image thereof and extracted by the component installer prior to installation and deployment. In another option, the configuration descriptions may be in a component descriptor and accessed before downloading the software component to be installed.

The component installer uses a software performance model of the system. The performance model may be built as, for example, a Layers Queuing Network (LQN). The solution of a LQN may be analytically calculated using, for example, Methods of Layer (MOL) or Stochastic Rendezvous Network (SRVN) techniques. Both MOL and SRVN permit system performance to be described in terms of response times and utilization of both hardware and software nodes. The software component to be installed is represented by a software node. MOL and SRVN do not necessarily require excessive computation times relative to typical processing power in an embedded consumer product such as a handheld device. With appropriate parameterization of the MOL and SRVN models, these methods are feasible to be used in handheld devices with limited computation power and a complex-to-model software system. The methods of calculating the software-performance models are not limited to the above-mentioned methods; rather, any analytical method operating on the same type of input data that can be calculated with reasonable effort may be used.

Output(s) from the calculations represent the solution to the problem addressing whether or not the software component can be deployed with acceptable performance. If the answer is “yes”, there may be more than one possible configuration. Which of the possible configurations is to be chosen may be decided manually by the user or automatically by a decision algorithm. The latter can, for example, be performed according to a given usage profile (e.g., game device, office device, multimedia device). A choice can be made, for example, on which CPU to execute an application, whether hardware support is used by the software, or if the software is to be executed as native code, Java code, precompiled Java code, or .Net code.

Choices may also limit the concurrency of tasks being executed in parallel. However, the requirements of the software component must also be taken into consideration. For example, the software component might need to access specific hardware or might have dependencies to specific software and thus must be located on a specific software layer. Thus, various parameters may be taken into account by the decision algorithm. If the user makes the decisions manually, there is a need for more-comprehensive and possibly less-technical information as a basis for making an appropriate decision regarding the software-component installation.

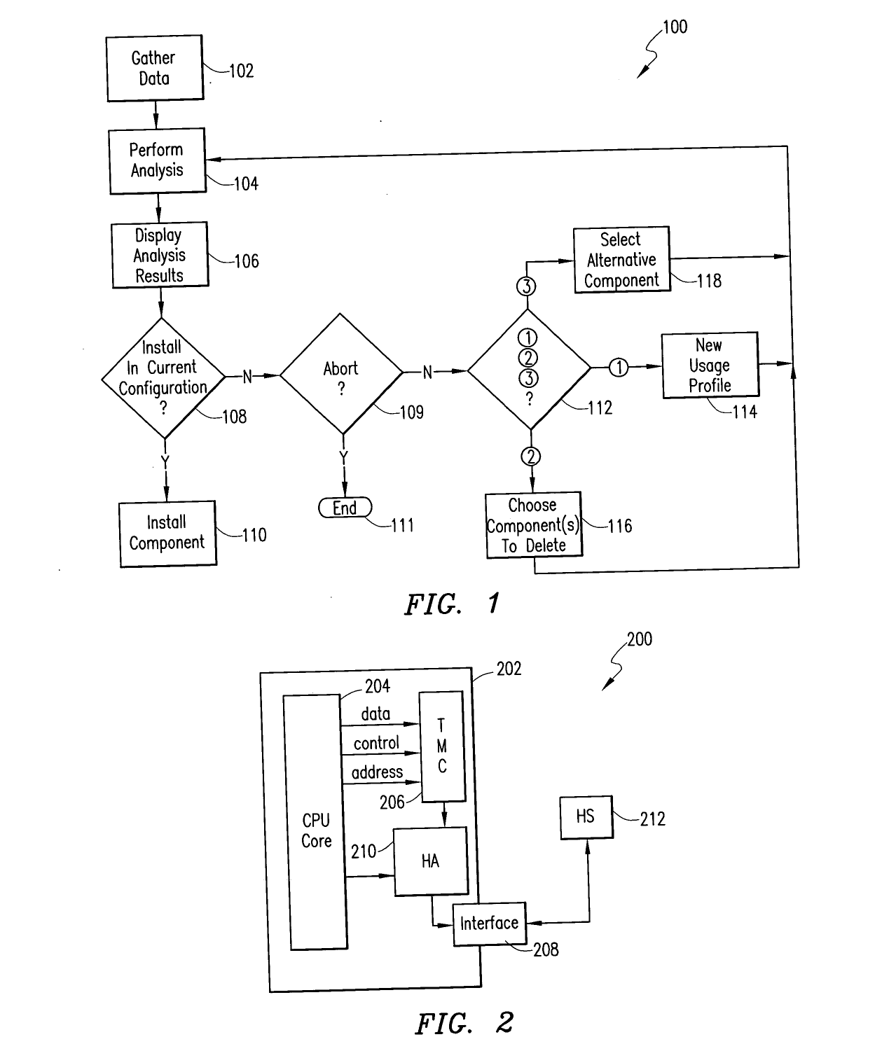

FIG. 1 is a flow chart illustrating performance analysis and software-component installation in accordance with principles of the invention. A flow 100 begins at step 102, at which step data for software-performance analysis is gathered. At step 104, the software-performance analysis is performed. At step 106, the results of the analysis performed at step 104 are displayed to a user. The results displayed at step 106 may, for example, inform the user whether any performance degradation is expected to result from installation of the software component. At step 108, the user is given a choice whether to install the software component in a current configuration. If at step 108, the user decides to install the software component in the current configuration, execution proceeds to step 110. At step 110, the software component is installed. If several system configurations are possible, the choice of a desired configuration could be made by the system or left to the user at step 110.

If, at step 108, the user decides to not install the software component in the current configuration, execution proceeds to step 109. At step 109, a determination is made whether to abort the software-component installation. If it is determined, at step 109, to abort the software-component installation, execution ends at step 111. If, at step 109, it is not determined to abort the software-component installation process, execution proceeds to step 112. At step 112, the user is presented with a plurality of options. For example, the user could be presented at step 112 with three options. In a first option, the user decides to perform the analysis at step 104 using another usage profile. In the first option, execution proceeds to step 114, at which step the user is presented with a number of usage profiles describing how the handheld device should be used. When the user has chosen a usage profile of preference, execution proceeds to step 104, at which step a new performance analysis is performed.

In a second option, the user decides to delete one or more already-installed software components. In response to the user choosing the second option, execution proceeds to step 116. At step 116, the user is presented with a number of components that are currently installed on the handheld device. When the user has chosen the component(s) to be deleted, the chosen component(s) are deleted and execution returns to step 104, at which step the analysis is performed based upon a performance model that no longer includes the deleted component(s).

In a third option, the user may select an alternative software component. If, at step 112, the user chooses the third option, the user is typically presented with a set of alternative software components. If the user decides to go ahead and test for installation of one of the set of alternative software components at step 118, execution returns to step 104, at which step the performance analysis is performed using the alternative component.

A performance analysis may also be performed after the installation of the software component has been performed, such as, for example, during system idle time. The performance analysis may be scheduled a given time intervals or trigged by predefined activities. However, gathering of the relevant data for the performance analysis is not performed during idle time, but is instead performed during normal usage of the system. The relevant data is predefined according to the configuration descriptions for the system.

When the performance analysis is performed after the installation of the software component, estimates for the software component, which are used as inputs to an analytical algorithm, do not result in a definitive and conclusive configuration. Instead, the system performance of different configurations can be calculated and the system software reconfigured for optimal performance. Additionally, more time can be used to find an optimal system configuration relative to performing the calculations during the software-component installation. The additional time available may be used to include more details in the model or to try more configurations.

When an analysis is to be preformed during installation, a decision algorithm for choosing a software configuration is typically of relatively-low complexity, due to restrictions on the installation time expected to be tolerated by a user. In addition, the initial estimates of software components can be revised when new and more accurate values are collected during run-time operation.

The component installer may reside either in the same system where the software component is to be installed or in a separate system external to the system in which the software component is to be installed. In the latter case, the model and performance database are distributed to a processing node of the system, at which the analysis is performed via, for example, a mandatory transmission channel (e.g., 3G, BLUETOOTH, WAN) and a mandatory software distributed component technology (e.g., CORBA, Java Beans, COM).

The system may be a mobile terminal equipped with one or several processing units (e.g., CPU, digital signal processor (DSP) or dedicated hardware accelerators) and a software system including a plurality of software components. The software system may wirelessly connect to a network via, for example, Global System for Mobile communications (GSM), General Packet Radio Service (GPRS), Enhanced GSM Data Evolution (EGDE), Wideband Code Division Multiple Access (WCDMA), BLUETOOTH, or Wireless Local Area Network (W-LAN). After connecting to the network, the user may, for example, identify new software components to be installed onto the mobile terminal.

Before the software component is installed, a component descriptor may be downloaded and the analytical calculations conducted. The calculations may be performed on, for example, the mobile terminal. After the calculations have been completed, the user may be prompted to install the software component. If the user decides to install the software component, the software component may be downloaded over the network and installed. In a variation of the above-described mobile terminal, the user is, after the calculations, prompted to install different variants of the software component, where, for example, one variant requires less system performance but provides less functionality, while another variant provides more functionality but consumes more system performance such that the system may show degradation in some cases.

From the point of view of a wireless network operator, there is a need to ensure real-time requirements of network connections for all possible configurations of a platform of a handheld device. Ensuring these real-time requirements can be a constant headache for the operator, who wants to have a highly-stable network that generates economic revenue, in contrast to users and manufacturers, who tend to fill the platform with more and more resource-demanding software components.

Gathering of system performance data is crucial to software performance estimation as performed by the component installer. System performance measurements often imply monitoring function calls or operating-system process swapping. In many modern embedded systems, process swapping can occur at rates exceeding 20 kHz, thereby generating a considerable amount of data. For example, assuming two words of data (1 word for a process ID, 1 word for timing information) gives a data rate of 40 kB/s. Assuming a trace run of about 100 seconds will obligate the system to handle 4 MB of data. Even if today's dedicated systems permit data rates of this order of magnitude to be handled, the measurement time is typically limited to minutes by the available external trace buffer. Even more bandwidth would be needed if OS signals sent between the processes or memory allocations were to be tracked.

A hardware accelerator for providing reliable and accurate software performance data to the component installer is proposed. In the context of the component installer, the hardware accelerator permits the data to be obtained without imposing high processing requirements on the embedded device. Platform developers, operators, and application developers are typical users of the hardware accelerator. The hardware accelerator can collect and reduce the data required for software performance analysis. Data reduction is achieved by a pre-analysis implemented in hardware. Used in this way, the hardware accelerator is one way to obtain the input data required for the analysis performed at step 104 of FIG. 1. Instead of requiring expensive and complex equipment to acquire large amounts of trace data typically used in software-performance analysis and estimation, pre-analyzed data can be requested from the hardware accelerator via, for example, an API.

In contrast to a trace macro cell (or similar unit) or a small trace buffer, which are sometime incorporated in today's embedded systems, the hardware accelerator may deliver ready-to-use data, instead of crude trace files, thereby serving to minimize analysis effort and required bandwidth.

Embedded-system design performance analysis can, for example, require extraction of program execution traces. Extracting the program execution traces usually requires dedicated hardware that is only usable by highly-skilled engineers and extensive and complex analysis of the resulting program execution traces. The extraction and analysis of the program execution traces is a big hurdle in the effort to attain optimal performance. Moreover, ever-increasing CPU clock speeds impose a challenge relative to acquisition of sufficient tracing information, since bandwidth for sending trace information from the system to external storage for later analysis is limited and often does not increase at the same pace as does clock speed.

The hardware accelerator permits a configurable pre-analysis to be performed of trace data acquired, for example, by a conventional trace buffer or embedded trace macro cell (or similar unit) before transmission to an external host for storage and further analysis. An API permits integration of the hardware accelerator with an operating system used in the embedded system or an external host used to store and analyze the data. Use of the hardware accelerator typically reduces the amount of collected performance data by several orders of magnitude via an analysis procedure implemented in hardware. The data rate to be sent to a host system or to be handled on the embedded system is accordingly reduced. The hardware accelerator also allows the performance data to be used directly from software running on the embedded system such as, for example, in the case of the component installer. Assigning an extra hardware block for the analysis causes the embedded system to be less affected by the measurement procedure.

The hardware accelerator may be adapted to perform analyses relative to: 1) execution times of operating-system processes; 2) call dependencies between processes; 3) signal latencies; 4) inter-arrival times of the processes to an OS kernel; 5) system waiting times; and 6) waiting times in OS signal queues. Data gathering for the component installer may also be realized on the embedded platform only, without the involvement of an external host.

FIG. 2 illustrates an exemplary hardware accelerator in accordance with principles of the invention. A system 200 includes an embedded system 202. The embedded system 202 includes a CPU core 204 and a trace macro cell (or similar unit) 206. The embedded system 202 is equipped with a hardware accelerator block 210 for accelerating software performance estimations. The hardware accelerator block 210 receives data from the trace macro cell (or similar unit) 206, which in turn monitors data, address, and control flow from the CPU core 204. A data link allows reading out data gathered by the hardware accelerator 210. The data link can be connected to an external host system (HS) 212. The host system 212 can populate a performance database used by a component installer via an analysis program and a data link.

In FIG. 2, trace data is first obtained by the trace macro cell (or similar unit) 206 triggered on a pre-determined event such as, for example, a write to a specific address, presence of specific data on a data bus, or execution of a specific instruction. For example, the trace macro cell (or similar unit) 206 could be configured to trigger on swapping in and out of OS processes. Data might be recorded on which process is swapped in at which time.

The information typically extracted from such a trace may be represented in a list showing, for example, process identifier, execution time for the identified process, how often the identified process was swapped in, how much memory the identified process allocated, and which other processes were called and how often. The listed information would most often occupy only KB of data; moreover, after some time, the amount of memory needed to store the list will remain constant, thereby allowing the system to be traced for a longer time without encountering memory-storage concerns.

The hardware accelerator 210 takes the data from the trace macro cell (or similar unit) 206 and performs various analytical steps, which may include: 1) counting occurrences of specific memory addresses in a data stream (e.g., to collect statistics on access to a specific data structure or occurrence of a function call); 2) counting occurrences of specific data words in the data stream (e.g., to trigger on a process ID during process switches); 3) calculating the difference between a tagged value in the data stream with a stored value and accumulating this value in a memory cell (e.g., to sum up execution times of a certain process); and 4) counting the occurrence of a certain instruction (e.g., to count how often an ARM mode switch from ARM to Java mode occurs).

After the analysis by the hardware accelerator 210 has been completed, results may be written from the hardware accelerator 210 to the host system 212. The host system 212 may further analyze the data before the data is used to populate the performance database or system description used by the component installer. To perform the above-described analytical steps, the hardware accelerator 210: 1) triggers on properties of the data provided by the trace macro cell (or similar unit) 206; 2) associates a store, or simple arithmetic operation, with the trigger; 3) performs a table lookup with the triggered data and associates a simple arithmetic operation with the looked-up element; 4) performs a table lookup with the triggered data and associates another table element with the looked-up table entry. It is estimated that a gate count for a hardware accelerator with the above capabilities, as well as data storage for the analysis results, would fit into approximately 20k gates.

The hardware accelerator 210 may be supported with an interface 208. The interface 208 allows the hardware accelerator 210 to be configured for, for example, collecting data needed by the component installer. For example, trigger conditions could be set and associated actions specified, as well as starting and stopping of measurements and outputting of data to the host system 212. Use of the hardware accelerator 210 permits platform developers, phone manufacturers, and network operators to receive performance data directly from an embedded product (i.e., a handheld device) without the need for complicated and expensive measurement equipment. The hardware accelerator 210 also allows data to be effectively and automatically gathered for the component installer. Since the trace data is pre-analyzed in the hardware accelerator 210, the need for data storage and bandwidth is greatly reduced and long time traces can be recorded. Moreover, constant monitoring of the system performance is possible.

The previous Detailed Description is of embodiment(s) of the invention. The scope of the invention should not necessarily be limited by this Description. The scope of the invention is instead defined by the following claims and the equivalents thereof.

1. A software performance-analysis and installation method comprising:
estimating performance of a system including a software component to be installed on the system;
determining, based on the estimated performance, whether to install the software component in a current configuration;
responsive to a determination to install the software component in the current configuration, installing the software component in the current configuration; and
responsive to a determination not to install the software component to be installed in the current configuration, performing one of the following four steps:
deleting at least one software component of the system;
determining a new usage profile;
aborting installation of the software component to be installed; and
selecting an alternative software component to be installed.

2. The software performance-analysis and installation method of claim 1, further comprising, responsive to a step performed responsive to the determination not to install the software component in the current configuration, returning to the estimating step.

3. The software performance-analysis and installation method of claim 1, wherein the estimating step comprises:
determining at least one configuration description of the system as configured without the software component to be installed;
determining at least one configuration description of the software component to be installed; and
performing calculations using the at least one configuration description of the system as configured without the software component to be installed and the at least one configuration description of the software component to be installed.

4. The software performance-analysis and installation method of claim 3, wherein the at least one configuration description of the system as configured without the software component to be installed comprises at least one of:
a structure of software on the system;
service requirements of at least one software component on the system in terms of hardware processing demand; and
at least one usage profile.

5. The software performance-analysis and installation method of claim 3, wherein the at least one configuration description of the software component to be installed comprises at least one of:
at least one of hardware processor usage and memory usage requirements of the software component to be installed; and
at least one of required services from other software components and acceptable response times from the system.

6. The software performance-analysis and installation method of claim 1, wherein each of the steps of deleting at least one software component of the system, determining a new usage profile, and selecting an alternative software component to be installed may be performed responsive to the determination not to install the software component to be installed in the current configuration.

7. The software performance-analysis and installation method of claim 1, wherein less than all of the steps of deleting at least one software component of the system, determining a new usage profile, and selecting an alternative software component to be installed may be performed responsive to the determination not to install the software component to be installed in the current configuration.

8. The software performance-analysis and installation method of claim 3, wherein the step of performing calculations comprises using a software-performance model of the system.

9. The software performance-analysis and installation method of claim 1, wherein the steps are performed on the system.

10. The software performance-analysis and installation method of claim 1, wherein at least one of the steps is performed externally to the system.

11. The software performance-analysis and installation method of claim 1, wherein:
the estimating step comprises using a software performance model of the system; and
the software performance model is built as a Layers Queuing Network (LQN).

12. The software performance-analysis and installation method of claim 11, wherein a solution of the LQN is analytically calculated using at least one of Methods of Layer (MOL) and Stochastic Rendezvous Network (SRVN) techniques.

13. An article of manufacture for software performance-analysis and installation, the article of manufacture comprising:
at least one computer readable medium;
processor instructions contained on the at least one computer readable medium, the processor instructions configured to be readable from the at least one computer readable medium by at least one processor and thereby cause the at least one processor to operate as to:
estimate performance of a system including a software component to be installed on the system;
determine, based on the estimated performance, whether to install the software component in a current configuration;
responsive to a determination to install the software component in the current configuration, install the software component in the current configuration; and
responsive to a determination not to install the software component to be installed in the current configuration, perform one of the following four operations:
delete at least one software component of the system;
abort installation of the software component to be installed;
determine a new usage profile; and
select an alternative software component to be installed.

14. The article of manufacture for software-performance analysis and installation of claim 13, wherein the processor instructions are further configured to cause the at least one processor to operate as to perform a new performance estimation responsive to an operation performed responsive to the determination not to install the software component in the current configuration.

15. The article of manufacture of claim 13, wherein the performance estimation comprises:
determining at least one configuration description of the system as configured without the software component to be installed;
determining at least one configuration description of the software component to be installed; and
performing calculations using the at least one configuration description of the system as configured without the software component to be installed and the at least one configuration description of the software component to be installed.

16. The article of manufacture of claim 15, wherein the at least one configuration description of the system as configured without the software component to be installed comprises at least one of:
a structure of software on the system;
service requirements of at least one software component on the system in terms of hardware processing demand; and
at least one usage profile.

17. The article of manufacture of claim 15, wherein the at least one configuration description of the software component to be installed comprises at least one of:
at least one of hardware processor usage and memory usage requirements of the software component to be installed; and
at least one of required services from other software components and acceptable response times from the system.

18. The article of manufacture of claim 13, wherein each of the operations of deleting at least one software component of the system, determining a new usage profile, and selecting an alternative software component to be installed may be performed responsive to the determination not to install the software component to be installed in the current configuration.

19. The article of manufacture of claim 13, wherein less than all of the operations of deleting at least one software component of the system, determining a new usage profile, and selecting an alternative software component to be installed may be performed responsive to the determination not to install the software component to be installed in the current configuration.

20. The article of manufacture of claim 15, wherein the step of performing of the calculations comprises using a software-performance model of the system.

21. The article of manufacture of claim 13, wherein the operations are performed on the system.

22. The article of manufacture of claim 13, wherein at least one of the operations is performed externally to the system.

23. The article of manufacture of claim 13, wherein:
the performance estimation comprises use of a software performance model of the system;
the software performance model is built as a Layers Queuing Network (LQN).

24. The article of manufacture of claim 23, wherein a solution of the LQN is analytically calculated using at least one of Methods of Layer (MOL) and Stochastic Rendezvous Network (SRVN) techniques.

25. An embedded integrated circuit comprising:
a hardware accelerator for use in software-performance analysis, the hardware accelerator comprising an operating-system application programming interface and an external application programming interface;
an embedded CPU inter-operably connected to the hardware accelerator;
a trace unit inter-operably connected to the hardware accelerator and the embedded CPU; and
a data link interface for communicating with a host system external to the embedded integrated circuit via the external application programming interface.

26. The embedded integrated circuit of claim 25, wherein the trace unit is a trace macro cell and the trace macro cell obtains the data responsive to a pre-determined event.

27. The embedded integrated circuit of claim 26, wherein the pre-determined event is selected from the group consisting of a write to a specific address, presence of specific data on a data bus, execution of a specific instruction, and swapping in and out of operating-system processes.

28. The embedded integrated circuit of claim 25, wherein the hardware accelerator is adapted to perform at least one of the following calculations:
counting occurrences of specific memory addresses in a data stream;
counting occurrences of specific data words in the data stream;
calculating of a difference between a tagged value in the data stream with a stored value and accumulating the tagged value in a memory cell; and
counting occurrences of a certain instruction.

29. The embedded integrated circuit of claim 28, wherein, following performance of at least one of the calculations, the hardware accelerator is adapted to write results of the at least one of the calculations to the host system.

30. The embedded integrated circuit of claim 28, wherein the hardware accelerator is adapted to:
trigger on properties of data provided by the trace unit;
associates a store with the trigger;
performs a table lookup with the triggered data;
associates a simple arithmetic operation with the looked-up element; and
performs a table lookup with the triggered data; and
associate a table element with the looked-up table entry.

31. The embedded integrated circuit of claim 25, wherein the external application programming interface permits the hardware accelerator to be configured by the host system.

32. The embedded integrated circuit of claim 25, wherein the hardware accelerator is adapted to perform data collection for use in the estimating step of claim 1.

33. The embedded integrated circuit of claim 25, wherein the trace unit is integrated into the hardware accelerator.
